(19) United States
(12) Patent Application Publication
(10) Pub. No.: US 2020/0066503 A1
(43) Pub. Date: Feb. 27, 2020

(54) SAMPLE INTRODUCTION DEVICE, SYSTEM AND METHOD FOR MASS SPECTROMETRY

(71) Applicant: RAPIDSURE TECHNOLOGY CORP., New Taipei City (TW)

(72) Inventor: MIN-ZONG HUANG, New Taipei (TW)

(21) Appl. No.: 16/442,565

(22) Filed: Jun. 17, 2019

(30) Foreign Application Priority Data
Aug. 23, 2018 (TW) 107129517

(51) Int. Cl. H01J 49/04

(52) U.S. Cl. CPC H01J 49/0409

(57) ABSTRACT

A sample introduction device for mass spectrometry includes a sample plate. The sample plate includes a carriage and at least one nozzle. The nozzle is made of a conductive material. The nozzle is mounted on the carriage. The nozzle includes a sample-receiving chamber, a spout, and a gas passage. The spout communicates with the sample-receiving chamber. The gas passage extends between opposite sides of the nozzle. In use, a sample is loaded into the sample-receiving chamber. An ion source creates a high voltage difference between the nozzle and an analyzer inlet such that the sample in the sample-receiving chamber is ionized to produce ions when leaving the nozzle. Meanwhile, a gas supply device supplies gas to the gas passage to create a negative pressure at the spout such that the exiting gas accelerates the ions away from the nozzle.

### FIELD

The present disclosure relates to mass spectrometry, and more particularly to a sample introduction device, system and method for mass spectrometry.

### BACKGROUND

A mass spectrometer generally includes a sample introduction device, an ion source, a mass analyzer, and a detector. The sample introduction device introduces a sample to be analyzed into the ion source. The sample is ionized in the ion source to produce ions, and the ions enter the mass analyzer by an accelerating electric field. The mass analyzer separates the ions according to their mass-to-charge ratio. The detector detects the separated ions. Therefore, the molecular weight of a target molecule in the sample is obtained.

If the sample to be analyzed is a liquid, the sample introduction device may include a pump and a capillary. The liquid sample is introduced into the ion source through the capillary by the pump. The length of the capillary is long, e.g., tens of centimeters, and the inner diameter of capillary is small, e.g., less than 150 μm. The liquid sample often requires pretreatment to remove impurities therefrom to avoid blockage of the capillary by the sample. However, pretreatment process is complicated and affects the efficiency of the analysis. Moreover, the volume of the liquid sample required is often large, e.g., greater than 1 mL, resulting in limitations on the analysis of trace liquid samples. Additionally, after use, cleaning of the capillary is time consuming and requires a large amount of solvent.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic perspective view of an embodiment of a sample introduction device.

FIG. 2 is a schematic cross-sectional view of an embodiment of a nozzle.

FIGS. 3 and 4 are schematic cross-sectional views of an embodiment of a nozzle shown in use.

FIG. 5 is an operational schematic side view of an embodiment of a sample introduction system.

FIG. 6 is a schematic perspective view of an embodiment of a sample introduction device.

FIG. 7 is a schematic cross-sectional view of an embodiment of a nozzle.

FIGS. 8A, 8B, 8C and 8D are schematic cross-sectional views of an embodiment of a nozzle shown in use.

FIG. 9 is a flowchart of an embodiment of a sample introduction method for a sample introduction device.

FIG. 10 is a schematic cross-sectional view of an embodiment of a nozzle.

FIGS. 11 and 12 are mass spectra of samples analyzed by an embodiment of a nozzle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

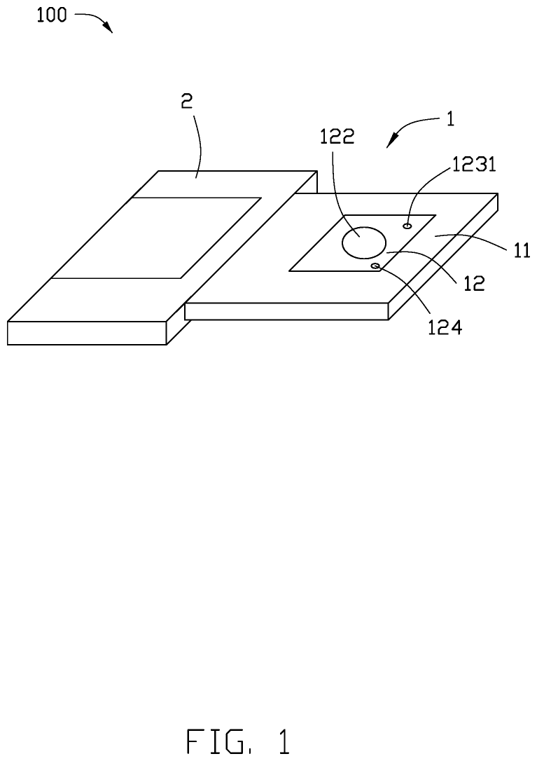

FIG. 1 is a schematic perspective view of an embodiment of a sample introduction device. As shown in FIG. 1, a sample introduction device 100 includes a sample plate 1 and a hand-held member 2.

The sample plate 1 includes a carriage 11 and at least one nozzle 12. The nozzle 12 is made of a conductive material such as metal. The nozzle 12 is mounted on the carriage 11.

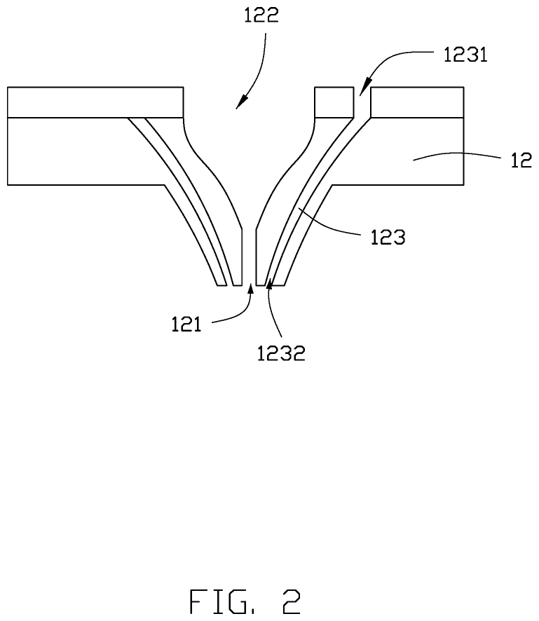

FIG. 2 is a schematic cross-sectional view of an embodiment of a nozzle. As shown in FIGS. 1 and 2, the nozzle 12 defines a sample-receiving chamber 122, a spout 121, and a gas passage 123. The sample-receiving chamber 122 is funnel shaped and narrows downwardly to the spout 121. The sample-receiving chamber 122 has a sample-receiving opening larger than the spout 121. The larger size of the sample-receiving opening facilitates liquid sample injection. The spout 121 is small such that a liquid sample can be prevented from leaking out of the spout 121 due to the liquid surface tension. The gas passage 123 is adjacent to the sample-receiving chamber 122, and extends from a top side to a bottom side of the nozzle 12. In this embodiment, the gas passage 123 is annular and surrounds the sample-receiving chamber 122 (e.g., arranged substantially symmetrically at both sides of the receiving chamber in a cross sectional view). In other embodiments, the gas passage 123 may be located at a side of the sample-receiving chamber 122, may be semi-annular, or may include a plurality of elongated passages (e.g., individual fluid tunnels arranged radially around the periphery of the receiving chamber in a plane view). The gas passage 123 has a gas inlet 1231 and a gas outlet 1232. The gas outlet 1232 is annular and surrounds the spout 121. More than one nozzle structures (e.g., nozzle 12) may be incorporated on a carriage (e.g., carriage 11 as shown in FIG. 1). The number of nozzles 12 depends on the needs of users. The nozzle 12 may further include an identification feature 124 on the top side thereof for mass spectrometric identification. Therefore, the user can know what kind of sample to be analyzed 200 in the sample-receiving chamber 122 of the nozzle 12 to appropriately adjust parameters of the ion source 300 such as voltage or gas pressure. The identification feature 124 may be a one-dimensional barcode, two-dimensional barcode, or identification circuit.

The hand-held member 2 is secured to one side of the carriage 11 of the sample plate 1. The hand-held member 2 and the carriage 11 are made of an insulating material such as plastic.

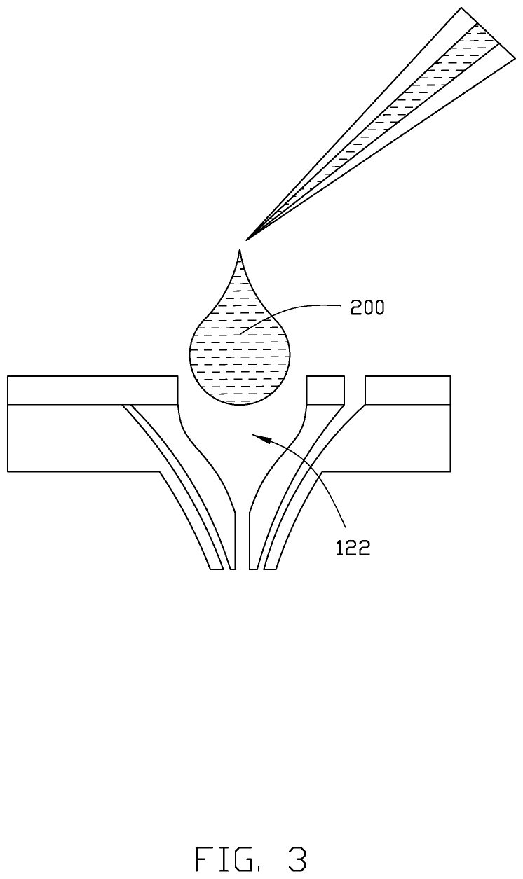

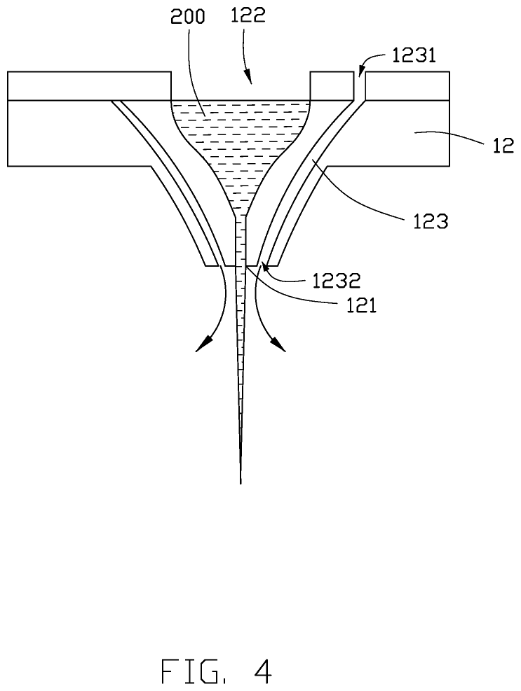

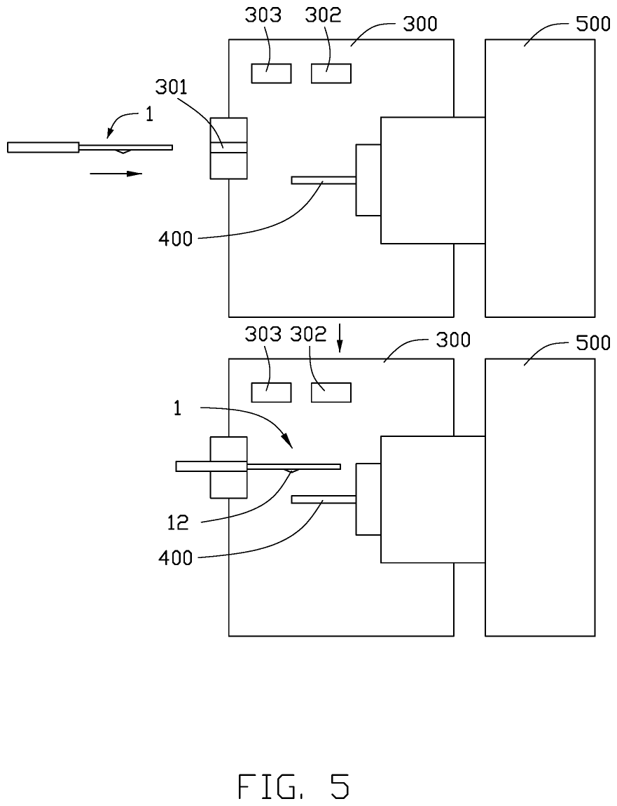

FIGS. 3 and 4 are schematic cross-sectional views of an embodiment of a nozzle shown in use. FIG. 5 is an operational schematic side view of an embodiment of a sample introduction system. In use, as shown in FIG. 3, the sample to be analyzed 200 is loaded into the sample-receiving chamber 122. As shown in FIG. 5, the sample plate 1 is then inserted into the ion source 300 through an insertion port 301. The ion source 300 applies a high voltage to create a high voltage difference between the nozzle 12 and an analyzer inlet 400. With further reference to FIG. 4, the sample to be analyzed 200 in the sample-receiving chamber 122 is ionized to produce ions when leaving the nozzle 12. Meanwhile, a gas supply device 302 supplies gas to the gas passage 123 through the gas inlet 1231 to create a negative pressure at the spout 121 such that the gas exiting the gas outlet 1232 accelerates the ions away from the nozzle 12. Additionally, a pressure difference is created between an atmospheric pressure in the ion source 300 and a vacuum pressure in an analysis device 500 such that the ions exiting the nozzle 12 are drawn through the analyzer inlet 400 into the analysis device 500 for analysis.

The applied voltage difference between the nozzle 12 and the analyzer inlet 400 may be about 4.5 kV to about 5.5 kV. The voltage difference may be adjusted based on a distance between the nozzle 12 and the analyzer inlet 400. The distance between the nozzle 12 and the analyzer inlet 400 is about 0.5 cm to about 2 cm, more preferably about 1 cm to about 1.5 cm. The ion source 300 includes at least one insertion port 301 at a front or side thereof.

When the sample to be analyzed 200 is sprayed from the nozzle 12, the sample to be analyzed 200 produces positive ions. To achieve that, in one embodiment, the nozzle 12 is connected to ground potential and the ion source 300 applies a negative high voltage to the analyzer inlet 400. In another embodiment, the analyzer inlet 400 is connected to ground potential and the ion source 300 applies a positive high voltage to the nozzle 12.

A sample introduction method includes that the sample to be analyzed 200 is loaded directly into the sample-receiving chamber 122, and the sample plate 1 is then inserted into the insertion port 301 of the ion source 300. The sample introduction method is easily performed such that the efficiency of the analysis is improved. The volume of the sample to be analyzed 200 required is only 1 to 5 μL so no large amount of liquid sample needs to be pretreated, thereby facilitating the analysis of trace liquid samples. Additionally, not only qualitative analysis of samples but also quantitative analysis of samples can be performed because the volume of the sample-receiving chamber 122 is fixed.

FIGS. 1 to 5 show an embodiment of a sample introduction device 100. The sample plate 1 includes one nozzle 12 mounted on the carriage 11.

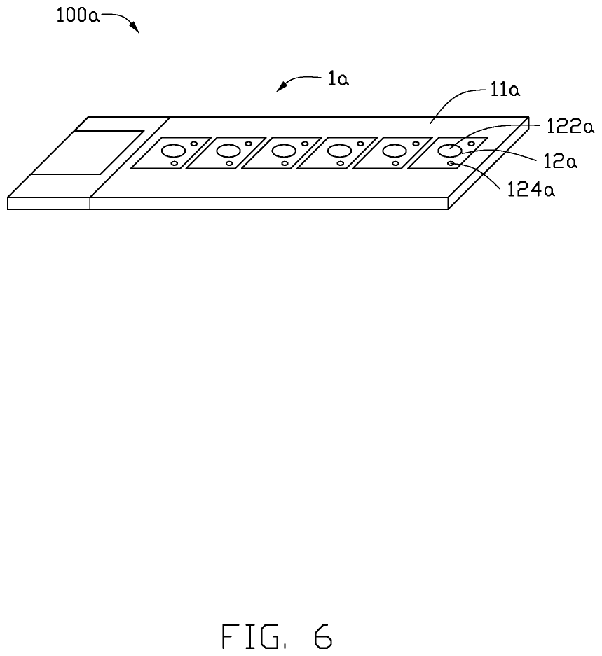

FIG. 6 is a schematic perspective view of an embodiment of a sample introduction device. FIG. 6 shows another embodiment of a sample introduction device 100a. The sample plate 1a includes a plurality of spaced apart nozzles 12a mounted on the carriage 11a. In this embodiment, six nozzles 12a are mounted on the carriage 11a. An automatic machine (not shown) may be disposed in the ion source 300 to sequentially load different samples to be analyzed 200 into the sample-receiving chambers 122a of the nozzles 12a. A scanning device 303 shown in FIG. 5 may be disposed in the ion source 300 to store information of each sample to be analyzed 200 based on the identification feature 124a of each nozzle 12a. In another embodiment, a storage device (not shown) may be mounted on the carriage 11a to store information of each sample to be analyzed 200 and a reading device (not shown) may be disposed in the ion source 300 to read the information stored in the storage device when the sample plate la is inserted into the ion source 300.

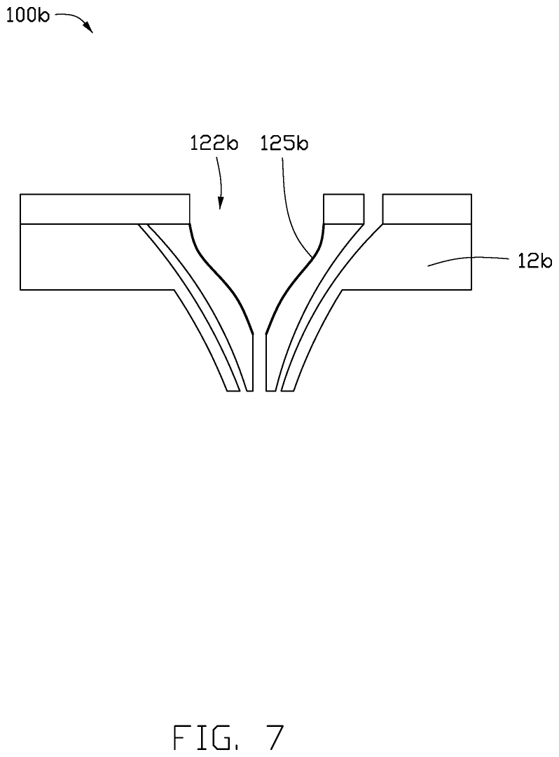

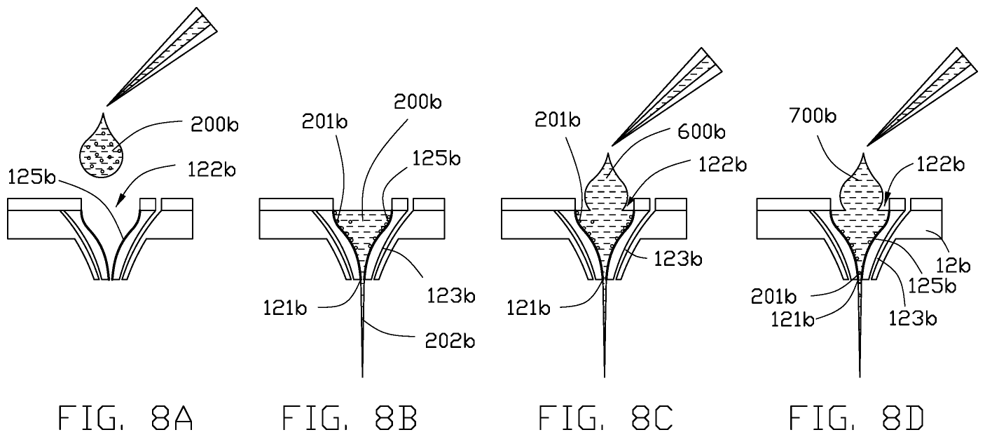

FIG. 7 is a schematic cross-sectional view of an embodiment of a nozzle. FIGS. 8A, 8B, 8C and 8D are schematic cross-sectional views of an embodiment of a nozzle shown in use. As shown in FIGS. 7-8D, the nozzle 12b has a functional group coating 125b on an interior surface of the sample-receiving chamber 122b. The functional group coating 125b may include nanoparticles. The functional group coating 125b can be a hydrophobic coating having C8 or C18 alkyl groups, a hydrophilic coating having nitrile or amide groups, or other coating having intermolecular forces. Functional groups of the functional group coating 125b can be bonded to the target molecules 201b in the sample to be analyzed 200b for washing and concentrating an analyte to improve the sensitivity and accuracy of mass spectrometry.

In an embodiment, the nozzle 12b has a silicon-containing coating (not shown) on the interior surface of the sample-receiving chamber 122b. The silicon-containing coating may include glass, quartz or silicone. A solution containing functional groups is loaded into the sample-receiving chamber 122b, and the solution is then removed after the functional groups are bonded to silicon atoms for a certain period of time, thereby forming the functional group coating 125b. For example, the target molecules 201b in the sample to be analyzed 200b are proteins such that a C18 alkyl coating is required. A solution containing C18 alkyl groups is loaded into the sample-receiving chamber 122b and a reagent is added to control pH of the solution, and the solution is then removed after the C18 alkyl groups are bonded to silicon atoms, thereby forming the C18 alkyl coating.

In an embodiment, processes of FIGS. 8A-8D are all performed by the automatic machine in the ion source 300. In another embodiment, the process of FIG. 8A is performed manually outside of the ion source 300, and the processes of FIGS. 8B-8D are performed by the automatic machine in the ion source 300.

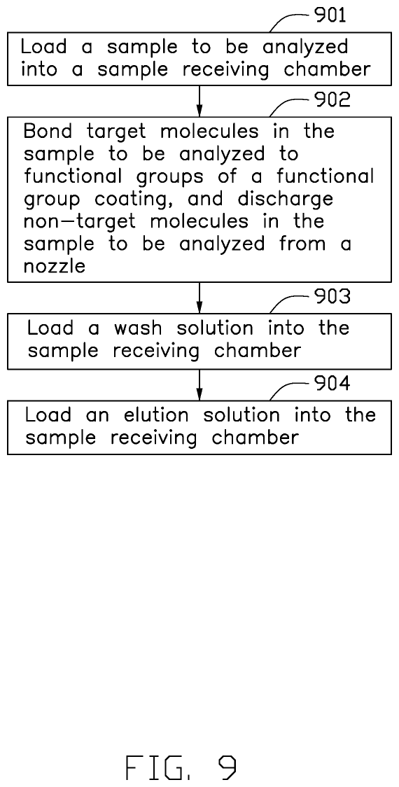

FIG. 9 is a flowchart of an embodiment of a sample introduction method for a sample introduction device. As shown in FIG. 9, a sample introduction method includes the following processes 901-904.

In process 901, as shown in FIG. 8A, the sample to be analyzed 200b is loaded into the sample-receiving chamber 122b.

In process 902, as shown in FIG. 8B, the target molecules 201b in the sample to be analyzed 200b are bound to the functional groups of the functional group coating 125b, and non-target molecules 202b in the sample to be analyzed 200b are slowly discharged from the spout 121b. After a predetermined reaction time, the gas supply device 302 supplies gas to the gas passage 123b to create a negative pressure at the spout 121b to accelerate the non-target molecules 202b away from the spout 121b.

In process 903, as shown in FIG. 8C, a wash solution 600b is loaded into the sample-receiving chamber 122b to rinse off remaining non-target molecules 202b. The gas supply device 302 supplies gas to the gas passage 123b to create a negative pressure at the spout 121b to accelerate the remaining non-target molecules 202b away from the spout 121b.

In process 904, as shown in FIG. 8D, an elution solution 700b is loaded into the sample-receiving chamber 122b to interrupt intermolecular forces between the target molecules 201b and the functional groups of the functional group coating 125b. The ion source 300 applies a high voltage to create a high voltage difference between the nozzle 12b and the analyzer inlet 400 to dissociate the target molecules 201b into ions. Meanwhile, the gas supply device 302 supplies gas to the gas passage 123b to create a negative pressure at the spout 121b to accelerate the ions into the analysis device 500 for analysis. Related processes are described above with reference to FIG. 4.

For example, when it is desired to test whether or not the sample to be analyzed 200b contains proteins, the C18 alkyl coating is required. In the process of FIG. 8B, the proteins and the C18 alkyl groups are bound together by intermolecular forces if the sample to be analyzed 200b contains the proteins, and inorganic or organic salts may adhere to the interior surface of the sample-receiving chamber 122b after the remaining sample is discharged from the spout 121b. In the process of FIG. 8C, the wash solution 600b is used to rinse off the salts to avoid salt interference during mass spectrometry. In the process of FIG. 8D, the elution solution 700b is used to interrupt intermolecular forces between the proteins and the C18 alkyl groups.

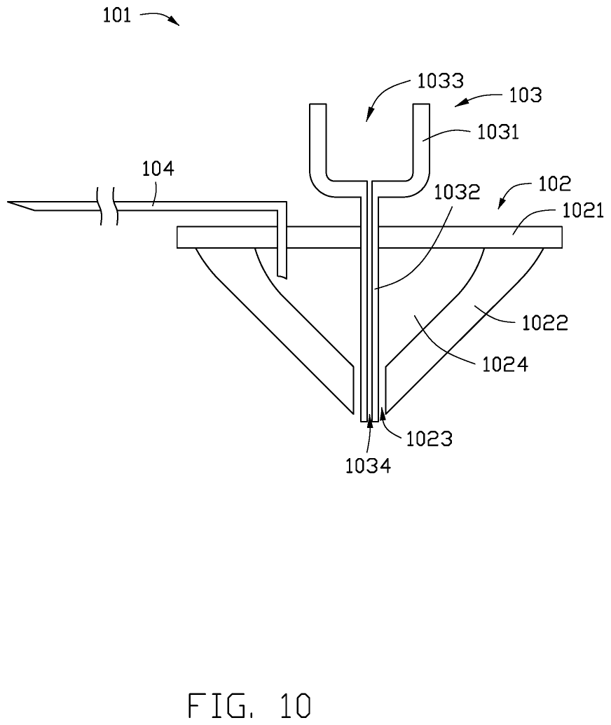

FIG. 10 is a schematic cross-sectional view of an embodiment of a nozzle. As shown in FIG. 10, the nozzle 101 includes a base 102, a funnel 103, and a gas supply pipe 104. The base 102 includes a plate 1021, an annular wall 1022, and a gas chamber 1024. The annular wall 1022 is connected to a bottom surface of the plate 1021. The annular wall 1022 is tapered and has a gas outlet passage 1023. The gas chamber 1024 is formed between the plate 1021 and the annular wall 1022. The gas chamber 1024 is in communication with the gas outlet passage 1023. The funnel 103 includes a carriage 1031 and a tube 1032. The carriage 1031 includes a sample-receiving chamber 1033. The tube 1032 is connected to a bottom end of the carriage 1031. The tube 1032 is disposed through the plate 1021 of the base 102 to be located in the gas chamber 1024. The tube 1032 has a spout 1034 at its bottom. The gas outlet passage 1023 is annular and surrounds the tube 1032. The gas supply pipe 104 is disposed through the plate 1021 of the base 102. The gas supply pipe 104 has an end located in the gas chamber 1024. The annular wall 1022 and the funnel 103 are made of a conductive material.

In use, mass spectrometry parameters are set such as voltage is set to 5.5 kV and gas pressure is set to 20 psi. A sample to be analyzed with a volume of 100 μL and a concentration of 1.0×10⁻⁴ M is loaded into the sample-receiving chamber 1033. The sample is then ionized in the ion source 300 to produce ions, and the ions enter the analysis device 500 to obtain a mass spectrum.

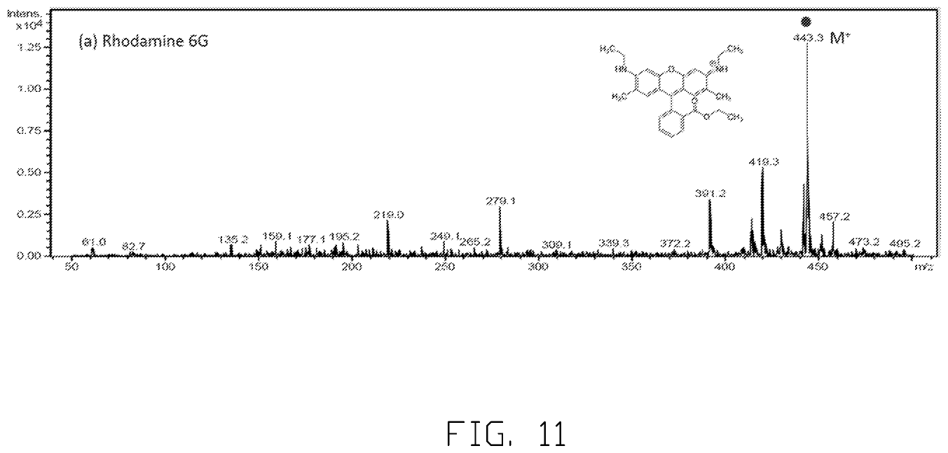

If the sample to be analyzed contains small molecules of Rhodamine 6G a mass spectrometry scan range is set from m/z 50 to m/z 500, and a resulting mass spectrum is shown in FIG. 11. The mass spectrum shows that the ion peak of Rhodamine 6G is m/z 443.3.

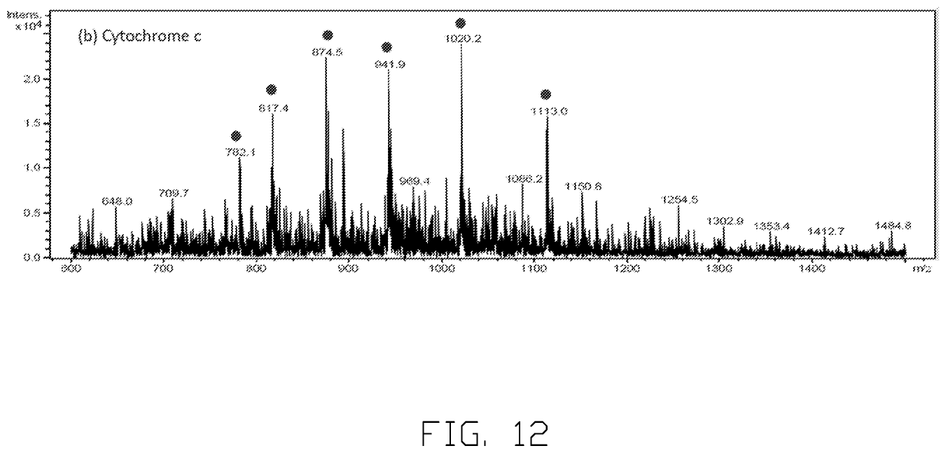

If the sample to be analyzed contains large molecules of cytochrome C, a mass spectrometry scan range is set from m/z 600 to m/z 1500, and a resulting mass spectrum is shown in FIG. 12. The mass spectrum shows a distribution of multiply charged ions of cytochrome C, and the ion peaks are m/z 782.1, m/z 817.4, m/z 874.5, m/z 941.9, m/z 1020.2 and m/z 1113.0.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A sample introduction device comprising:
a sample plate having:
a carriage; and
at least one nozzle made of a conductive material, the nozzle mounted on the carriage, and the nozzle that defines:
a sample-receiving chamber;
a spout communicating with the sample-receiving chamber; and
a gas passage extending between opposite sides of the nozzle;
wherein the gas passage has a gas inlet and a gas outlet that enable fluid communication between opposite sides of the sample plate.

2. The sample introduction device of claim 1, wherein the sample-receiving chamber is funnel shaped.

3. The sample introduction device of claim 1, wherein the gas passage is annular and surrounds the sample-receiving chamber.

4. The sample introduction device of claim 3, wherein the gas outlet of the gas passage is annular and surrounds the spout.

5. The sample introduction device of claim 1, wherein the nozzle has an identification feature.

6. The sample introduction device of claim 1, further comprising a hand-held member secured to the carriage.

7. The sample introduction device of claim 6, wherein the sample plate has a plurality of spaced apart nozzles mounted on the carriage.

8. The sample introduction device of claim 1, wherein the nozzle has a functional group coating on an interior surface of the sample-receiving chamber.

9. The sample introduction device of claim 8, wherein the functional group coating comprises nanoparticles.

10. A sample introduction system comprising:
an ion source having an insertion port; and
a sample introduction device configured to be inserted into the ion source through the insertion port, and the sample introduction device comprising:
a sample plate having:
a carriage; and
at least one nozzle made of a conductive material, the nozzle mounted on the carriage, and the nozzle that defines:
a sample-receiving chamber;
a spout communicating with the sample-receiving chamber; and
a gas passage extending between opposite sides of the nozzle;
wherein the gas passage has a gas inlet and a gas outlet that enable fluid communication between opposite sides of the sample plate.

11. The sample introduction system of claim 10, wherein the sample-receiving chamber is funnel shaped.

12. The sample introduction system of claim 10, wherein the gas passage is annular and surrounds the sample-receiving chamber.

13. The sample introduction system of claim 12, wherein the gas outlet of the gas passage is annular and surrounds the spout.

14. The sample introduction system of claim 10, wherein the nozzle has an identification feature.

15. The sample introduction system of claim 10, further comprising a gas supply device configured to supply gas to the gas passage.

16. The sample introduction system of claim 14, further comprising a scanning device configured to store information of a sample to be analyzed based on the identification feature of the nozzle.

17. The sample introduction system of claim 16, wherein the ion source is configured to adjust parameters based on the information of the sample to be analyzed.

18. The sample introduction system of claim 10, wherein the ion source is configured to create a voltage difference between the nozzle and an analyzer inlet.

19. A sample introduction method for a sample introduction device comprising:
loading a sample to be analyzed into a sample-receiving chamber of a nozzle of the sample introduction device;
bonding target molecules in the sample to be analyzed to functional groups of a functional group coating on an interior surface of the sample-receiving chamber, and discharging non-target molecules in the sample to be analyzed from the nozzle;
loading a wash solution into the sample-receiving chamber; and
loading an elution solution into the sample-receiving chamber.

20. The sample introduction method of claim 19, wherein the functional group coating comprises nanoparticles.
